(19) United States
(12) Patent Application Publication
(10) Pub. No.: US 2026/0290642 A1
(43) Pub. Date: Sep. 24, 2026

(54) BUS DEVICE

(71) Applicant: SCHNEIDER ELECTRIC (CHINA) CO., LTD., BEIJING (CN)

(72) Inventors: Xianfeng SONG, Guangzhou (CN); Jianyuan HUANG, Guangzhou (CN); Jianliang HUANG, Guangzhou (CN); Tianwen LIN, Guangzhou (CN); Yanbing HE, Guangzhou (CN)

(21) Appl. No.: 19/153,210

(22) PCT Filed: Aug. 8, 2023
(86) PCT No.: PCT/CN2023/111665

§ 371 Date: Aug. 1, 2025

(30) Foreign Application Priority Data
Aug. 9, 2022 (CN) 202210951410.9

(51) Int. Cl. H01B 5/02; H01B 1/02; H01B 5/00; H01B 9/02; H01R 4/38; H01R 13/03; H01R 25/16

(52) U.S. Cl. CPC H01B 5/02; H01B 1/02; H01B 5/002; H01B 9/02; H01R 4/38; H01R 13/03; H01R 25/162

(57) ABSTRACT

The present disclosure relates to a bus device. The bus device (100) comprises: a first bus and a second bus, each bus (10) comprising a bus connection area, and the bus connection area comprising a first conductive coating (12). The bus connection area of the first bus and a bus connection area of the second bus are in direct contact with each other in a longitudinal direction to form an electrical contact, or the bus connection area of the first bus and the bus connection area of the second bus are spaced apart from each other in the longitudinal direction and are configured to be electrically connected via an additional connection conductor (22). Therefore, the electrical contact performance at the bus joint of the bus device is improved.

This application claims priority to a Chinese patent application for an invention having Application No. 2022109514109 and entitled “BUS DEVICE” filed on Aug. 9, 2022, the disclosure of which is incorporated herein by reference in its entirety.

### FIELD

Embodiments of the present disclosure generally relate to power transmission field, and more specifically, to a bus device.

### BACKGROUND

Bus is extensively applied in power systems for power transmissions. Bus is usually made of aluminum or copper material and has a generally flat shape and a given cross segment area, which cross segment area is related to the size of the allowable current. A plurality of segments of buss usually need to connect with each other to extend length of the bus; in addition, the bus also can be provided with a plurality of power-taking points, so as to branch a plurality of downstream lines from the bus.

After servicing a long time, the bus often has surface oxidation issue, resulting into significantly increased contact resistance at the joint of the bus and severely degraded conductive performance of the bus. To solve such issue, the traditional joint area is usually provided with a bimetallic strip to suppress oxidation. Although the bimetallic strip can solve the above issue, it is required to attach the bimetallic strip by spot welding, which complicates the process. Besides, when it is required to arrange the bus on site, the use of an electric welding machine would increase the fixed investment costs of the user. Further, the bimetallic strip can only be arranged at a position suitable for point welding, so the arrangement area of the bimetallis strip is restricted. There is an expectation to improve the traditional bus to lower the overheads of the bus and/or improve the performance of the bus.

### SUMMARY

Embodiments of the present disclosure provide a bus device, to address one or more of the above and other potential problems.

In accordance with a first aspect of the present disclosure, there is provided a bus device. The bus device comprises: a first bus and a second bus, each bus comprising a bus connection area consisting of a first conductive coating; wherein a bus connection area of the first bus and a bus connection area of the second bus are in direct contact with each other in a longitudinal direction to form an electrical contact, or a bus connection area of the first bus and a bus connection area of the second bus are spaced apart from each other in the longitudinal direction and configured to be electrically connected via an additional connection conductor. The bus device according to embodiments of the present disclosure enhances the electrical contact performance at the bus connection joint, lowers the contact resistance and improves electrical contact reliability by forming a first conductive coating on the bus connection area.

In some embodiments, the bus device also comprises a bus connector comprising the connection conductor, the connection conductor comprising a second conductive coating at least in a part in contact with the bus connection area of the first bus and/or the bus connection area of the second bus, wherein the bus connection area and the connection conductor (22) form an electrical contact through a contact between the first conductive coating (12) and the second conductive coating. Accordingly, the reliable connection between the adjacent buss can be implemented through the bus connector and the electrical contact performance at the connection joint between the bus and the connection conductor can be ensured by the second conductive coating. Therefore, the performance of the bus device is further enhanced.

In some embodiments, the connection conductor comprises the second conductive coating at least at an entire surface of a contact side. Accordingly, the second conductive coating can be conveniently formed and even if the conductive coating is provided, the assembly can also be performed easily. In some embodiments, the second conductive coating is present on both surfaces of the connection conductor, which can further facilitate the assembly work of the bus device.

In some embodiments, the bus comprises: a conductive body made of a first conductive material; and the first conductive coating made of a second conductive material different from the first conductive material.

In some embodiments, the first conductive coating is coated on the bus connection area by cold spraying particles of the second conductive material. As such, the conductive coating can be conveniently formed at low costs. Besides, the cold spray method allows to form the conductive coating at any suitable areas of the bus, which makes it possible to provide the conductive coating at any conductive joints. Further, since the conductive coating can be formed during the manufacturing process of the bus, no coating work is required at the installation site and the hardware investment costs of the installation site are further reduced.

In some embodiments, the first conductive material is selected from copper and aluminum and the second conductive material is selected from at least one of copper, silver and tin.

In some embodiments, a thickness of the conductive coating is no less than 0.02 mm. Therefore, the performance of the conductive contact can be ensured.

In some embodiments, a longitudinal length of the conductive coating is no less than three times of a thickness of the bus, which can ensure the performance of the conductive contact.

In some embodiments, the conductive body comprises a first longitudinal end and a second longitudinal end, at least one of the first longitudinal end and the second longitudinal end comprising the first conductive coating and forming the bus connection area. Therefore, the electrical contact performance of the bus device at the longitudinal joint can be improved.

In some embodiments, wherein the conductive body comprises a middle segment located between the first longitudinal end and the second longitudinal end; the middle segment comprises a top surface and a bottom surface; wherein at least one of the top surface and the bottom surface comprises one or more area providing the third conductive coating and the bus is configured to form an electrical contact with at least one conductor transversely via the third conductive coating at the one or more areas. Accordingly, the electrical contact performance at the transverse power-taking point of the bus is improved by the third conductive coating.

In some embodiments, the one or more areas include two areas arranged side by side, such that the bus can form an electrical contact with a plurality of conductors respectively transversely via the two areas; and/or the one or more areas comprise a plurality of areas arranged longitudinally, such that the bus can form an electrical contact with at least one conductor via the plurality of areas.

In some embodiments, the bus also comprises paired contact blades, each contact blade of the paired contact blades comprising a fourth conductive coating at least at a part in electrical contact with a further conductor, wherein the paired contact blades are configured to be fixed together by clamping the further conductor with a fastener. Therefore, the transverse power taking can be implemented via the paired contact blades and the electrical contact performance at the transverse power-taking point of the bus is improved by the fourth conductive coating.

In some embodiments, each contact blade of the paired contact blades comprises the fourth conductive coating at least at an entire surface of a contact side.

In some embodiments, the bus further comprises at least one protrusion projecting from a transverse lateral surface of the conductive body; the protrusion comprising a top surface and a bottom surface, at least one of the top surface and the bottom surface comprising a fifth conductive coating; and the bus being configured to form an electrical contact with a further conductor transversely via the protrusion. Therefore, the transverse power-taking points can be implemented by the protrusion and the electrical contact performance at the transverse power-taking point of the bus can be improved by the fifth conductive coating.

### BRIEF DESCRIPTION OF THE DRAWINGS

Through the following detailed description with reference to the accompanying drawings, the above and other objectives, features, and advantages of embodiments of the present disclosure will become more apparent. Several example embodiments of the present disclosure will be illustrated by way of example but not limitation in the drawings.

FIG. 1 illustrates a stereogram of a bus device according to an embodiment of the present disclosure.

FIG. 2 illustrates an exploded view of a bus device according to an embodiment of the present disclosure.

FIG. 3 illustrates a schematic diagram of a connection between two buss according to an embodiment of the present disclosure.

FIG. 4 illustrates a schematic diagram of a bus device according to another embodiment of the present disclosure.

FIG. 5 illustrates a schematic stereogram of a bus having transverse power-taking points according to an embodiment of the present disclosure.

FIG. 6 illustrates a schematic stereogram of a bus having transverse power-taking points according to another embodiment of the present disclosure.

FIG. 7 illustrates a schematic stereogram of a bus having transverse power-taking points according to a further embodiment of the present disclosure, wherein a power-taking joint is mounted to the bus.

FIG. 8 illustrates a schematic stereogram of a bus having transverse power-taking points according to a further embodiment of the present disclosure, wherein the power-taking joint is spaced apart from the bus.

FIG. 9 illustrates a schematic stereogram of a bus having transverse power-taking points according to a further embodiment of the present disclosure.

FIG. 10 illustrates a schematic stereogram of a bus having transverse power-taking points according to a further embodiment of the present disclosure, wherein the power-taking joint is mounted to the bus.

FIG. 11 illustrates a flowchart of a method for manufacturing a bus according to one embodiment of the present disclosure.

FIG. 12 illustrates a schematic diagram of a system for manufacturing a bus according to one embodiment of the present disclosure.

In each drawing, same or corresponding reference signs indicate same or corresponding parts.

### DETAILED DESCRIPTION OF EMBODIMENTS

Preferred embodiments of the present disclosure will be described in more details below with reference to the drawings. Although the drawings show the preferred embodiments of the present disclosure, it should be understood that the present disclosure can be implemented by various manners and should not be limited to the embodiments explained herein. On the contrary, the embodiments are provided for a more thorough and complete understanding of the present disclosure and to fully convey the scope of the present disclosure to those skilled in the art.

As used herein, the term “comprises” and its variants are to be read as open-ended terms that mean “comprises, but is not limited to.” The term “or” is to be read as “and/or” unless the context clearly indicates otherwise. The term “based on” is to be read as “based at least in part on.” The terms “one example embodiment” and “one embodiment” are to be read as “at least one example embodiment.” The term “another embodiment” is to be read as “at least one another embodiment”. The terms indicating placement or positional relation, such as “up”, “down”, “front”, “back” and the like, depend on orientational or positional relations illustrated in the drawings and are provided merely for explaining the principle disclosed herein, rather than indicating or suggesting that the specified element must have the particular orientation or be constructed or operated according to the particular orientation. These terms should not be interpreted as limitations to the present disclosure.

As stated above, copper or aluminum bus usually faces the issue of significantly increased contact resistance induced by oxidation. This issue can be eased or partly addressed by providing a bimetallic strip at a bus joint. However, it takes massive costs and complicated operations to form the bimetallic strip. For this, a new bus is provided according to embodiments of the present disclosure. The bus comprises, at the joint, a conductive coating made of a second conductive material different from a material of the bus body, so as to enable the electrical connection between the two conductors through the conductive coating at the joint. With the conductive coating, the forming method becomes simple. Besides, the conductive coating can also be formed at any suitable positions according to the requirements, which can significantly enhance the bus performance. The bus according to the embodiments of the present disclosure is to be explained in details below with reference to the drawings.

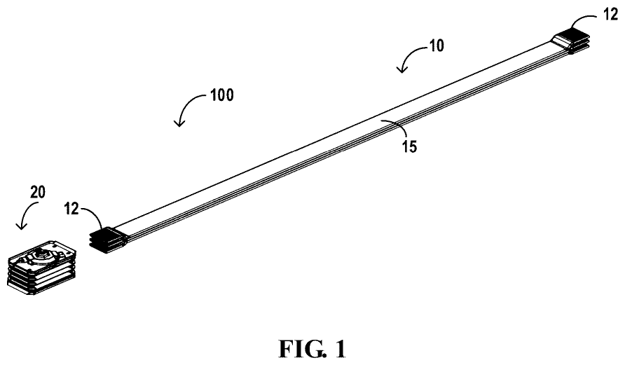

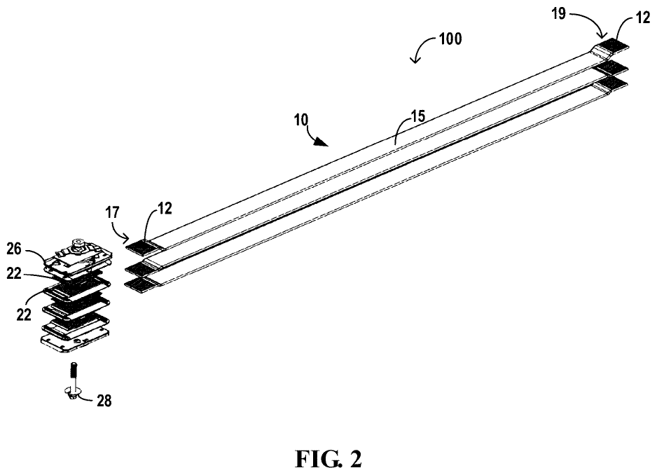

FIGS. 1 and 2 illustrate stereograms of a bus device 100 in accordance with embodiments of the present disclosure. As shown in FIGS. 1 and 2, the bus device 100 can include a bus 10 extending in the longitudinal direction (only one bus is schematically illustrated in the drawings). The bus 10 is formed to have a predetermined longitudinal length. “Longitudinal” here refers to an extension direction of the bus, which extension direction is consistent with the current flow direction. A plurality of buses 10 can be connected to one another to form an extended bus. Depending on the power transmission distance, the plurality of buss 10 can be linked in series along the longitudinal direction, to supply the power to a desired position. In the illustrated embodiments, the bus device 100 can be a three-phase power and can include three first buss arranged side by side. It is to be explained that the above configuration is only exemplary and the bus device also can include other numbers of buses.

The bus device 100 also can include a bus connector 20. The bus connector 20 can be used for fastening the adjacent bus 10 to each other to enable the electrical connections among the buses. The bus connector has various implementations.

In some embodiments, the adjacent buses do not directly contact with each other. Instead, the electrical connections of the adjacent buses can be fulfilled by setting a connection conductor in the bus connector. As shown in FIG. 2, the bus connector 20 can be provided for connections of multi-phase buses and can include a plurality of connection conductors 22, an insulating plate 26 and a fastener 28 etc. The connection conductor 22 can be provided with a via; and the fastener 28 can be used to fixate the connection conductor 22, the insulating plate 26 and the adjacent buses 10 together. A part of the connection conductor 22 contacts one bus and a further part of the connection conductor 22 contacts another bus. The adjacent buses and the connection conductors are mounted together via the fastener 28, to enable the electrical connections of the adjacent buses.

In some embodiments, according to FIGS. 1 and 2, the bus 10 can include a conductive body 15 made of a first conductive material and a first conductive coating 12 made of a second conductive material different from the first conductive material. In the illustrated embodiments, the conductive coating 12 is demonstrated in the form of fill lines. The conductive coating 12 can be arranged on a contact surface area of the conductive body 15. The term “contact surface area” refers to a joint area of the bus, at which the bus is in electrical contact with a further bus or a conductor.

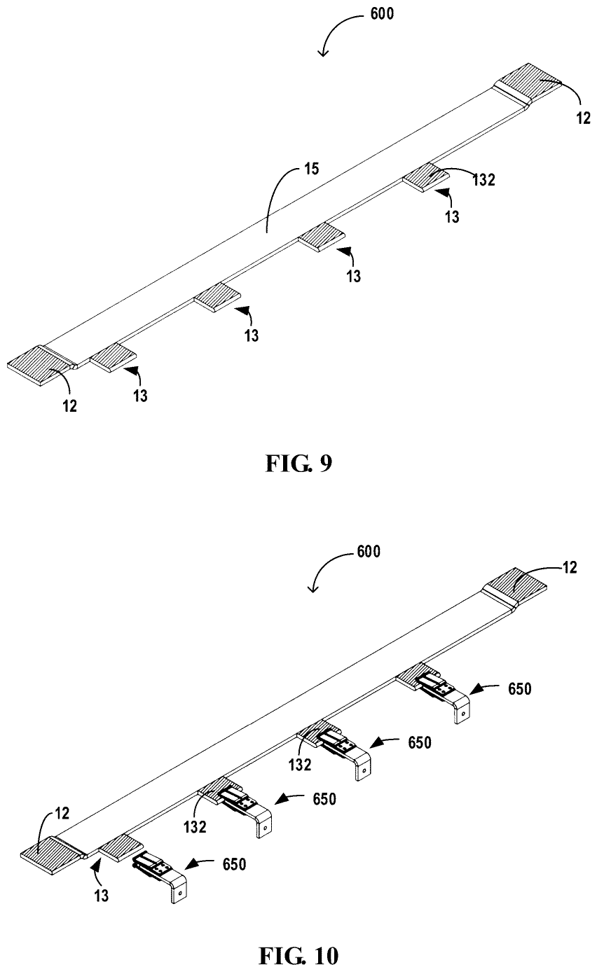

According to the embodiments of the present disclosure, the conductive coating made of a material different from the material of the conductive body 15 is arranged at the joint area of the bus and the electrical connections between the bus and other conductors are enabled by the conductive coating, to effectively overcome the deficiencies caused by surface oxidation and potential corrosion of the bus. As the formation is made through coating and electro-welding is no longer required, the process complexity can be effectively lowered. Besides, the coating for example can be pre-formed in factory and the users only need to perform the assembly work on site, without additional processes like electro-welding. This lowers the usage inconvenience for users and decreases related hardware and labor costs. Further, the conductive coating also can be conveniently formed using a small amount of metals, which can lower the overhead of the bus. The coating is formed by a spraying process, so it can be formed at any suitable positions. The coating can be applied as long as the shape or configuration features of each part of the bus would not interfere the coating process. In comparison to the traditional bimetallic strip configuration, the number of areas to which the coating can be applied remarkably increases. There are many ways to form the conductive coating on the conductive body 15. As an example, the conductive coating 12 can be coated on the contact surface area by cold spraying particles of the second conductive material. The example manufacturing method is to be explained in details later with reference to FIG. 9. It should be appreciated that cold spray is just one embodiment for forming the coat and any other suitable methods can be adopted to form the conductive coating.

In some embodiments, the thickness of the conductive coating should no less than 0.02 mm. Accordingly, the desired effects can be achieved by an extremely thin conductive coating. In some embodiments, the thickness of the conductive coating can be 0.02 mm, 0.03 mm, 0.04 mm, 0.05 mm, 0.06 mm and 0.07 mm or greater.

In some embodiments, a longitudinal spray length of the conductive coating is no less than three times of the thickness of the bus, to ensure that the conductive coating can effectively play its role. In some embodiments, the longitudinal spray length of the conductive coating can be four times, five times, six times, seven times, eight times or more times of the thickness of the bus. The term “longitudinal spray length” here indicates a length of the bus in a current direction when in contact with a further conductor.

In some embodiments, the first conductive material for forming the conductive body 15 can be selected from one of copper and aluminum. The second conductive material is selected from at least one of copper, silver and tin. As an example, silver, tin and/or copper coating can be coated on the aluminum surface; silver and/or tin coating can be coated on the copper surface. In some embodiments, the aluminum surface can be coated with only the silver layer or the tin layer or the copper layer. In some embodiments, multiple metal layers of different materials can be coated on the aluminum surface. For example, the aluminum surface is first coated with a copper layer and then a silver layer and/or a tin layer.

With these materials, the aforementioned issues related to surface oxidation and surface potential corrosion can be effectively suppressed.

In some embodiments, as shown in FIG. 2, the conductive body 15 can include a first longitudinal end 17 and a second longitudinal end 19. The first longitudinal end 17 and the second longitudinal end 19 can both include a conductive coating 12. The bus 10 can be electrically connected to an adjacent bus through the first longitudinal end 17 and the second longitudinal end 19, to ensure that the joint area of the adjacent bus can be effectively protected by the conductive coating. In some embodiments, the conductive coating 12 can be arranged to cover the entire width of the first longitudinal end 17 and the second longitudinal end 19.

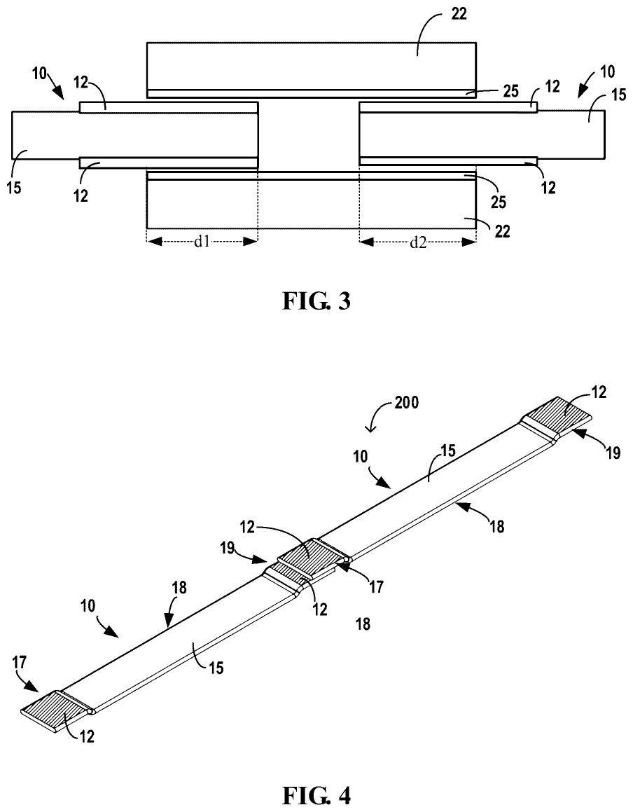

FIG. 3 schematically illustrates an example of implementing a longitudinal connection between two buses 10 with the bus connector 20. As shown in FIG. 3, the two buss 10 do not make contact directly. Instead, the connection conductor 22 makes contact with the two buss separately to electrically connect the two buses.

As shown in FIG. 3, the first conductive coating 12 is at least provided on the surface contact area of the bus and the connection conductor 22. The second conductive coating 25 is provided at least on the electrical contact surface of the connection conductor 22.

In the embodiment illustrated by FIG. 3, the bus 10 is arranged in such a way that the bus is clamped by two connection conductors 22. In such case, in the illustrated embodiment, both the positive and the negative surfaces of the bus are provided with the first conductive coating 12. The second conductive coating 25 is provided on a surface of the connection conductor 22 in contact with the bus. Therefore, it is ensured that the conductive coating is formed on each joint surface. It should be appreciated that the connection mode shown in FIG. 3 is applicable to one-phase power. The use of two connection conductors 22 is just exemplary. For each phase of power, the number of connection conductor can be more than two. In some embodiments, the parts of each connection conductor for forming electrical contact include the conductive coating; in other embodiments, the parts of some of the connection conductors for forming electrical contact include the conductive coating. In addition, the connection between the bus and the connection conductor can be implemented in any other suitable ways as long as a firm (e.g., pressure) contact is secured between them.

In some embodiments, the entire contact surface of the connection conductor 22 is provided with the conductive coating. In some embodiments, the conductive coating is provided only on a part of the connection conductor 22 in contact with the bus. Besides, in some embodiments, the entire surface of the connection conductor 22 facing the bus 10 can be provided with the conductive coating. In some embodiments, the positive and the negative surfaces of the connection conductor 22 can both be provided with the conductive coating, which is good for assembly.

FIG. 3 also illustrates a longitudinal spray length d1 and d2 of the conductive coatings 12 and 14, the longitudinal spray lengths d1 and d2 can correspond to the longitudinal length of the joint area of the bus 10. The longitudinal spray lengths d1 and d2 are no less than six times of the thickness of the conductive coatings 12 and 14, so as to ensure that the conductive coating can effectively play its role. The longitudinal spray lengths d1 and d2 can be seven, eight, ten and even more times of the thickness of the conductive coatings 12 and 14, to provide a larger contact margin.

FIG. 4 illustrates a schematic diagram of the bus device 200 in accordance with a further embodiment of the present disclosure. Different from the bus device 100 shown in FIGS. 1 and 2, two adjacent buses 10 can directly form an electrical contact through lap joint in the bus device 200. As shown in FIG. 4, the lap joint area of the bus device 200 can include the conductive coating 12.

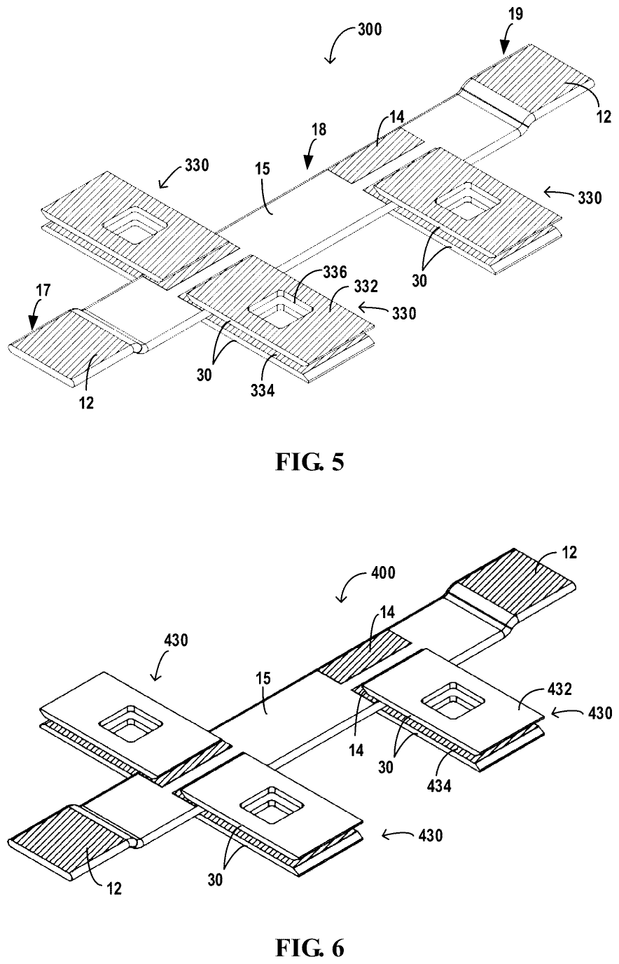

FIGS. 5-8 illustrates schematic stereograms of bus 300, 400 and 500 having transverse power-taking points in accordance with different embodiments of the present disclosure.

As shown in FIGS. 5-8, the conductive body 15 can include a middle segment 18 between the first longitudinal end 17 and the second longitudinal end 19. One or more areas of the middle segment 18 can be provided with a third conductive coating 14. Therefore, the bus 10 can form electrical contact with a plurality of conductors in a transverse direction via the third conductive coating 14 at one or more areas. By forming the conductive coating, the transverse power-taking points can be conveniently set on the bus 10. The power-taking point can be configured randomly based on the requirements with low costs and easy implementation. The third conductive coating 14 can be conveniently configured in accordance with the type of the power-taking interface. In some embodiments, the third conductive coating can be provided only on one surface of the middle segment 18. In some embodiments, the conductive coating can be provided on both the positive and the negative surfaces of the middle segment 18.

Depending on the setting requirements for the power-taking points, the third conductive coating 14 can be formed into various patterns. In some embodiments, the third conductive coating 14 can be adjacent to a transverse edge of the bus and can be arranged side by side. As such, the bus 10 can separately form two power-taking points adapted to take power transversely through the transversely isolated conductive coatings, which can advantageously save the amount of the third conductive coating 14 for use and ensure the reliable performance of the power-taking points. Although the third conductive coatings 14 are transversely spaced apart from each other in the illustrated embodiment, it is just an example. In other embodiments, the third conductive coating 14 can extend across the entire width of the bus. Although the third conductive coatings 14 are transversely arranged in pairs in the illustrated embodiment, it is just an example. In other embodiments, only one conductive coating can be provided.

In some embodiments, the third conductive coating 14 can be adjacent to the transverse edge of the bus and can be arranged in the longitudinal direction. Accordingly, the bus 10 can separately form a plurality of power-taking points adapted to take power in the longitudinal direction through the in the longitudinal direction spaced conductive coating, which can advantageously save the amount of the third conductive coating 14 for use and ensure the reliable performance of the power-taking points. It is noteworthy that the illustrated number of the third conductive coating 14 is just an example and any other suitable numbers of the third conductive coating 14 can be formed.

In some embodiments, as shown in FIG. 5, the bus 300 can include a transverse power-taking interface 330. The transverse power-taking interface can include paired contact blades 30. The structure in the form of paired contact blades is particularly suitable for scenarios with large currents. A power-taking conductor (not shown) can be fixed to the third conductive coating 14 through the paired contact blades 30. A part of the contact blades 30 can contact with the third conductive coating 14 and a further part of the contact blades 30 can be in contact with the power-taking conductor (not shown). Therefore, the contact blades 30 clamp the bus and the power-taking conductor in such a way that the bus and the power-taking conductor are in surface contact. In addition, the contact blades 30 can include a fastener hole 336, through which fastener hole (not shown) the contact blades 30, the power-taking conductor and the bus 10 are fastened together.

As shown in FIG. 5, the upper and lower surfaces of the contact blades 30 are both provided with fourth conductive coatings 332 and 334 (i.e., the shaded portion in the drawings). The bus and the paired contact blades 30 make contact through the conductive coating. Therefore, the electrical performance at the joint can be significantly improved.

It is to be understood that although the bus 300 only comprises four conductive coatings 14 in the illustrated embodiments, it is just for example. The bus 300 can be provided with any other suitable numbers of conductive coatings.

The embodiment shown by FIG. 6 is similar to that illustrated in FIG. 5. As shown in FIG. 6, the bus 400 can include a transverse power-taking interface 430. The transverse power-taking interface also can include paired contact blades 30. FIG. 6 differs from FIG. 5 in that only the electrical contact part (i.e., the shaded portion in the drawings) of the contact blades 30 is provided with the fourth conductive coating 434 and the non-electrical contact part 432 of the contact blades is not provided with the conductive coating. Both the positive and the negative surfaces of the contact blades 30 are provided with the conductive coating, which is good for assembly.

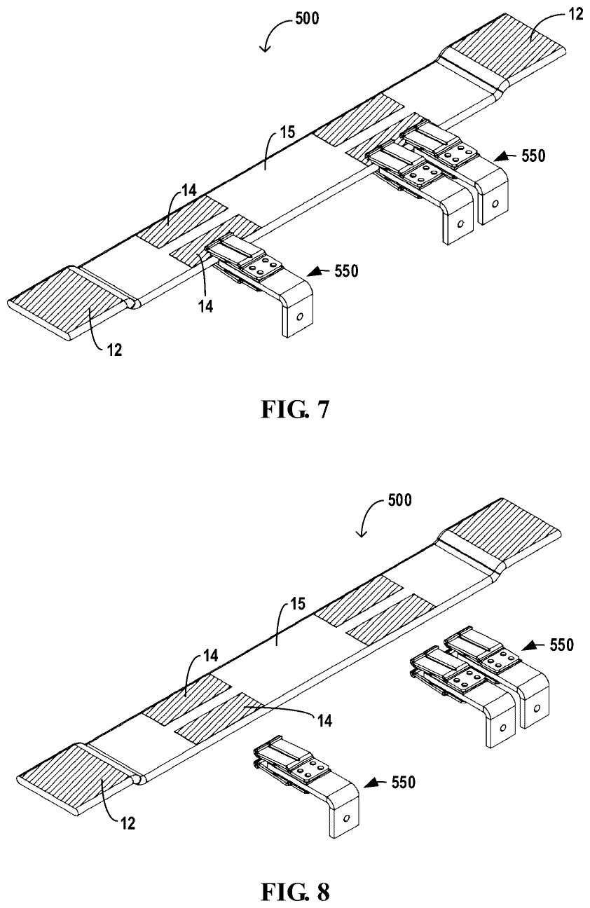

In some embodiments, the contact blades can not be provided. The power-taking conductor can directly contact with the bus. In the embodiments illustrated in FIGS. 7-8, the power-taking conductor 550 can include a pair of claws, the pair of claws being engaged with the bus 500 at the conductive coating 14. Since the bus 500 and the power-taking conductor 500 make direct contact through the conductive coating 14, the electrical performance at the joint can be significantly improved. Such bus structure is particularly suitable for scenarios with small currents.

FIGS. 9 and 10 illustrate schematic stereograms of the bus 600 having transverse power-taking points in accordance with different embodiments of the present disclosure. As shown in FIGS. 9 and 10, the bus 600 also comprises at least one protrusion 13 projecting from a transverse lateral surface of the conductive body 15. The protrusion 13 comprises a top surface and a bottom surface and at least one of the top surface and the bottom surface comprises a fifth conductive coating 132. Accordingly, the power-taking joint of the bus 600 can make an electrical contact with the power-taking interface 650 through the fifth conductive coating 132 on the protrusion 13. In some embodiments, both the top surface and the bottom surface of the protrusion 13 are provided with the fifth conductive coating 132. In some embodiments, either the top surface or the bottom surface of the protrusion 13 is provided with the fifth conductive coating 132. By providing the conductive coating on either the top surface or the bottom surface, the performance at the power-taking joint can be enhanced to a certain extent.

As shown in FIG. 10, the power-taking joint 650 can be formed in the form of power-taking claw. In some embodiments, the conductive coating according to the embodiments of the present disclosure can be selectively provided on the electrical contact surface of the power-taking joint 650, which can further improve the performance at the power-taking joint. It should be appreciated that this is just an example and the power-taking joint 650 also can be formed in any other suitable ways.

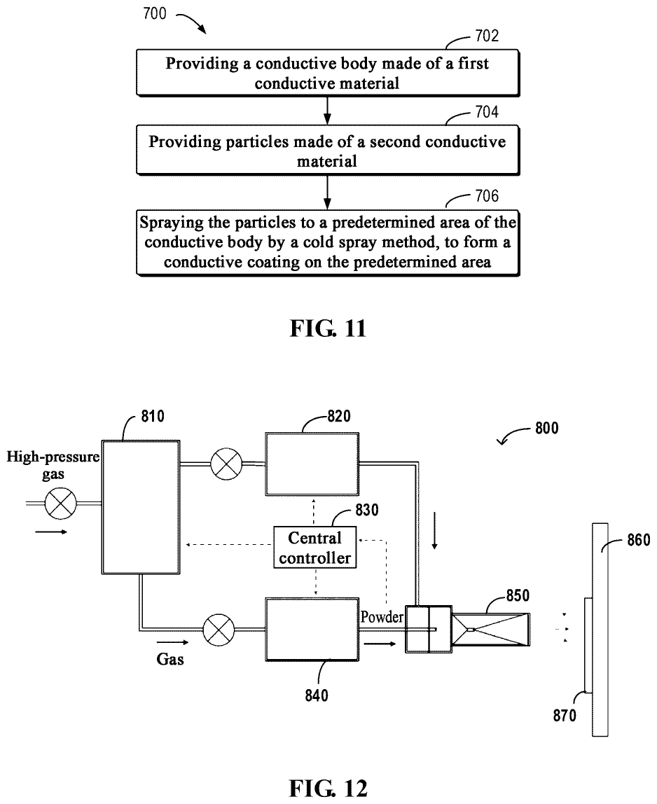

FIG. 11 illustrates a flowchart of a method 700 for manufacturing a bus in accordance with embodiments of the present disclosure. As shown in FIG. 11, the method 700 can comprise: providing a conductive body made of a first conductive material at block 702; providing particles made of a second conductive material at block 704; spraying the particles to a predetermined area of the conductive body by a cold spray method, to form a conductive coating on the predetermined area at block 706.

FIG. 12 illustrates a schematic diagram of a system 800 for manufacturing a bus in accordance with embodiments of the present disclosure. The system 800, for example, implements the method shown in FIG. 11 by high-speed cold spray.

As shown in FIG. 12, the system 800 can include a gas controller 810, a gas heating storage tank 820, a central controller 830, a metal powder tank 840 and a spray gun 850 etc. The high pressure gas is diverted under the control of a gas controller 810. A portion of the diverted gas is sent to the gas heating storage tank 820, and another portion is sent to the metal powder tank 840. The heated gas from the gas heating storage tank 820 is delivered to the spray gun 850 under the control of the central controller 830. At the same time, under the action of another gas, the powder in the metal powder tank 840 is delivered to the spray gun 850 (e.g., Laval spray gun). At the spray gun 850, the heated high-speed gas, on the one hand, pre-heats the metal powder and, on the other hand, imparts kinetic energy to the powder. At the spray gun 850, the thoroughly mixed powder fluid, when passing through the Laval tube, forms a high-speed fluid, which is splashed onto the substrate 860 to produce a mechanical anchoring effect, thereby forming a coating 870 on the substrate 860. Under the control of the central controller 830, the fluid can form a coating of a corresponding thickness on the substrate after being continuously sprayed at a high speed in view of the requirements. By appropriately selecting the spray area of the substrate 860, the coating 870 can be conveniently formed on a suitable area.

It is to be understood that the system 800 is only exemplary and can include any other suitable implementations.

Furthermore, although the respective operations are depicted in a particular order, it should be appreciated that the operations are not required to be completed in the particular order or in succession, or not all operations shown need to be executed to obtain the expected result. In some cases, multitasking or multiprocessing is also beneficial. Likewise, although the above discussion comprises some particular implementation details, they should not be interpreted as limitations over the scope of the present disclosure. Some features described separately in the context of the embodiments of the description can also be integrated and implemented in a single embodiment. Conversely, all kinds of features described in the context of a single embodiment can also be separately implemented in multiple embodiments or any suitable sub-combinations.

Although the subject matter has been described in languages specific to structural features and/or method actions, it should be understood that the subject matter defined in the attached claims is not limited to the above described particular features or actions. On the contrary, the above described specific features and actions are disclosed for implementing examples of the claims.

Various embodiments of the present disclosure have been described above and the above description is only exemplary rather than exhaustive and is not limited to the embodiments of the present disclosure. Many modifications and alterations, without deviating from the scope and spirit of the explained various embodiments, are obvious for those skilled in the art. The selection of terms in the text aims to best explain principles and actual applications of each embodiment and technical improvements made in the market by each embodiment, or enable those ordinary skilled in the art to understand embodiments of the present disclosure.

1. A bus device, comprising:
a first bus and a second bus, each bus comprising a bus connection area, the bus connection area comprising a first conductive coating;
wherein the bus connection area of the first bus and the bus connection area of the second bus are in direct contact with each other in a longitudinal direction to form an electrical contact, or
the bus connection area of the first bus and the bus connection area of the second bus are in the longitudinal direction spaced apart from each other in the longitudinal direction in the longitudinal direction and configured to be electrically connected via an additional connection conductor.

2. The bus device of claim 1, further comprising a bus connector, the bus connector comprising the connection conductor, the connection conductor comprising a second conductive coating at least in a part in contact with the bus connection area of the first bus and/or the bus connection area of the second bus, wherein the bus connection area and the connection conductor form an electrical contact through a contact between the first conductive coating and the second conductive coating.

3. The bus device of claim 2, wherein the connection conductor comprises the second conductive coating at least at an entire surface of a contact side.

4. The bus device of claim 1, wherein the bus comprises a conductive body made of a first conductive material; and the first conductive coating made of a second conductive material different from the first conductive material.

5. The bus device of claim 4, wherein the first conductive coating is coated on the bus connection area by cold spraying particles of the second conductive material.

6. The bus device of claim 4, wherein the first conductive material is selected from copper and aluminum, and the second conductive material is selected from at least one of copper, silver and tin.

7. The bus device of claim 4, wherein a thickness of the first conductive coating is no less than 0.02 mm.

8. The bus device of claim 4, wherein a longitudinal length of the first conductive coating is no less than three times of a thickness of the bus.

9. The bus device of claim 4, wherein the conductive body comprises a first longitudinal end and a second longitudinal end, at least one of the first longitudinal end and the second longitudinal end comprising the first conductive coating and forming the bus connection area.

10. The bus device of claim 9, wherein the conductive body comprises a middle segment located between the first longitudinal end and the second longitudinal end; the middle segment comprising a top surface and a bottom surface; wherein at least one of the top surface and the bottom surface comprises one or more area providing the third conductive coating, and the bus is configured to form an electrical contact with at least one conductor transversely via the third conductive coating at the one or more areas.

11. The bus device of claim 10, wherein the one or more areas comprises two areas arranged side by side, and the bus is configured to form an electrical contact with a plurality of conductors respectively transversely via the two areas; and/or
the one or more areas comprise a plurality of areas arranged in the longitudinal direction, and the bus is configured to form an electrical contact with a plurality of conductors respectively via the plurality of areas.

12. The bus according to claim 10, further comprising paired contact blades, each contact blade of the paired contact blades comprising a fourth conductive coating at least at a part in electrical contact with a further conductor, wherein the paired contact blades are configured to be fixed together by clamping the further conductor with a fastener.

13. The bus of claim 12, wherein each contact blade of the paired contact blades comprises the fourth conductive coating, at least at an entire surface of a contact side.

14. The bus device of claim 4, wherein the bus further comprises at least one protrusion projecting from a transverse lateral surface of the conductive body; the protrusion comprising a top surface and a bottom surface, at least one of the top surface and the bottom surface comprising a fifth conductive coating; and the bus being configured to form an electrical contact with a further conductor transversely via the protrusion.
